(19) United States
(12) Patent Application Publication
(10) Pub. No.: US 2011/0256208 A1
(43) Pub. Date: Oct. 20, 2011

(54) EDIBLE CARRIER FOR ANIMAL MEDICATION

(75) Inventor: KOW-JE LING, Taipei City (TW)

(73) Assignee: HERMOSA THIN FILM CO., LTD., Taipei City (TW)

(21) Appl. No.: 12/904,147

(22) Filed: Oct. 13, 2010

(30) Foreign Application Priority Data
Apr. 14, 2010 (TW) 099111597

(51) Int. Cl. A23K 1/165

(52) U.S. Cl. 424/442

(57) ABSTRACT

An edible carrier for animal medication includes a main body with an accepting space and a cover, where the main body and cover are all made of an animal food material. The main body and cover respectively have annular first and second walls corresponding to each other, where the first wall and second wall respectively have a first engagement unit and second engagement unit corresponding to each other. Medicine may be placed in the accepting space, and the cover is then coupled to the main body fixedly by engaging the first engagement unit with the second engagement unit such that the medicine can be secured in the main body, and the carrier has a general shape and odor of animal food, and is mixed together with the food conveniently to feed animals, ensuring that animals cannot differentiate medicine from the food, thereby allowing animals to eat the medicine effectively.

### BACKGROUND OF THE INVENTION

1. Field of the Invention

The present invention relates to a medicine carrier, and more particularly to an edible medicine carrier for animals such as cats, dogs and etc.

2. Description of Related Art

Most dog breeders have a common difficulty on feeding a dog with medicine; the dog would vomit the medicine placed inside its mouth or hide the medicine under its tongue and does not vomit the medicine until the breeder does not notice. If medicine is mixed in dog's food, a dog will eat all the food but leave the medicine in a bowl. The most reliable way to feed a dog with medicine is that one person pulls the dog's mouth apart, another person places the medicine down below the dog's throat, and then uses hands to close the dog's mouth tightly. Thereafter, the hands are not released until the medicine is swallowed in. But, doing so, the person is easy to be bitten by the dog, or the dog is hurt sometimes.

U.S. Pat. No. 5,853,757 discloses a carrier for animal medication, which is a carrier for pills, tablets, or capsules allowing for ease of oral consumption by animals. The carrier having a preformed chamber allowing for the insertion of medication therein, the carrier is deformable causes securement of the medication within the chamber. The carrier masks the scent of medication and including a lubricant to allow for ease of consumption of the carrier and contained medication.

U.S. Pat. No. 5,895,662 discloses a meat product pet medicine capsule; a hollowed pet treat for medicating a pet is provided including a vial constructed entirely of an edible product and defining an interior space and an open top. Next provided is a cap formed entirely of the edible product for being removably coupled to the open top of the vial for containing a predetermined medicine within the interior space.

In the edible carriers for animal medicine mentioned above, although the medicine is hidden in the interiors thereof thereby allowing an animal not to smell the odor of the medicine, the animal can still differentiated between medicine and animal food by the odor and the shape of the carrier. The animal might eat all the food but leave the carrier filled with medicine; an animal medicating effect cannot be completed successfully on this account.

### SUMMARY OF THE INVENTION

To improve an edible carrier for animal medication, the present invention is proposed.

The main object of the present invention is to provide an edible carrier for animal medication, having a shape and odor like animal's food, and being convenient to be mixed with the food together to feed animals, ensuring animals cannot differentiate between them.

Another object of the present invention is to provide an edible carrier for animal medication, convenient to be combined with animal medicine, and rather inseparable from the medicine.

### BRIEF DESCRIPTION OF THE DRAWINGS

The present invention can be more fully understood by reference to the following description and accompanying drawings, in which:

FIG. 1 is a schematic view of an edible carrier for animal medication of a first preferred embodiment according to the present invention;

FIG. 2 is an exploded view of an edible carrier for animal medication of the first embodiment according to the present invention;

FIG. 3 is a perspective view of an edible carrier for animal medication of a second preferred embodiment according to the present invention;

FIG. 4 is an exploded view of an edible carrier for animal medication of the second embodiment according to the present invention;

FIG. 5 is a schematic view of an edible carrier for animal medication of a third preferred embodiment according to the present invention;

FIG. 6 is an exploded view of an edible carrier for animal medication of the third embodiment according to the present invention;

FIG. 7 is a schematic view of an edible carrier for animal medication of a fourth preferred embodiment according to the present invention;

FIG. 8 is a perspective view, showing a main body and a cover of an edible carrier for animal medication of the fourth embodiment according to the present invention; and

FIG. 9 is an exploded view of an edible carrier for animal medication of the fourth embodiment according to the present invention.

### DETAILED DESCRIPTION OF THE PREFERRED EMBODIMENTS

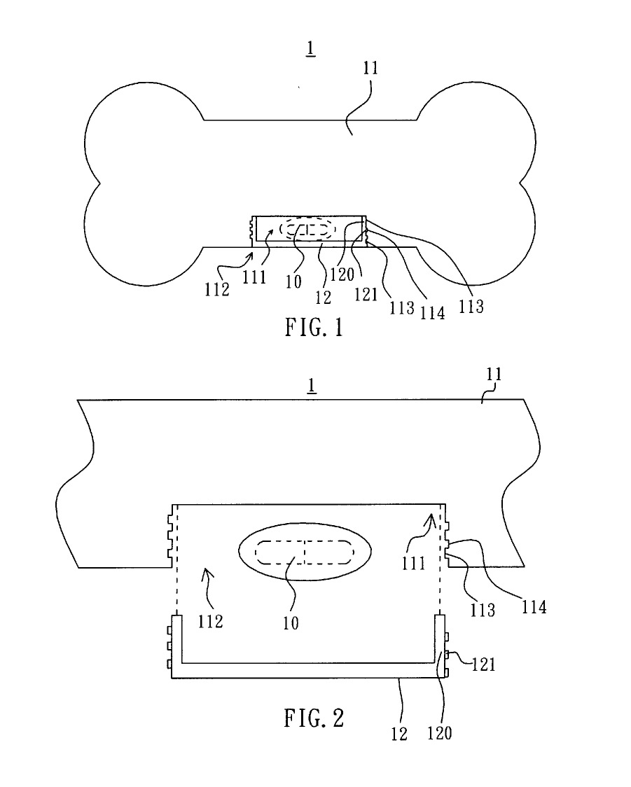

Referring to FIGS. 1 and 2, an edible medicine carrier 1 of a first preferred embodiment according to the present invention includes a main body 11 and a cover 12 which are all made of animal food, where the main body 11 has a shape of market available animal food, for example, a bone shape. An accepting space 111 is disposed inside the main body 11, and an opening 112 is disposed on the surface of the main body 11, where the opening 112 communicates with the accepting space 111. The main body 11 has a first wall 113 by which the accepting space 111 is formed, and the cover 12 has a second wall 120 corresponding to the first wall 113, where the first wall 113 and the second wall 120 respectively are annular, and respectively have a first engagement unit 114 and second engagement unit 121 corresponding to each other. The first engagement unit 114 and the second engagement unit 121 of the present embodiment respectively are internal threads and external threads corresponding to each other. A medicine 10 may be placed in the accepting space 111 of the main body 11, and the cover 12 is then allowed to couple fixedly to the main body 11 and close the opening 112 through the engagement of the first engagement unit 114 and the second engagement unit 121 so that the medicine 10 can be secured inside the main body 11.

When animals eat food, they always crump larger chunks of food, smell food fragments and then eat the food fragments. Therefore, a user may grind the medicine to powder, mixes it with a soft and sticky edible material such as cheese or starch paste, and then places the mixed stuff in the accepting space 211 and distribute it in the accepting space 211 as full as possible, thereby sticking cheese or starch paste to the cover 12 and the main body 11. Thereafter, the cover 12 is coupled fixedly to the main body 11 and shields the opening 112 conveniently by engaging the first engagement unit 114 with the second engagement unit 121. Furthermore, cheese or starch paste is dried and solidified to couple to the cover 12 and the main body 11 to form one body, thereby allowing the powder of the medicine 10 to be secured in the edible medicine carrier 1 stably. The powder of the medicine 10 is still retained in the fragments of the edible medicine carrier 1 and not separated therefrom even if the edible medicine carrier 1 is crumped by animals, ensuring that animals cannot differentiate between them and cannot smell the odor of the medicine 10 and eat the medicine 10 together with the fragments of the edible medicine carrier 1. Besides, cheese or starch paste may be further added with natural spice or artificial spice, thereby arousing animals' appetite.

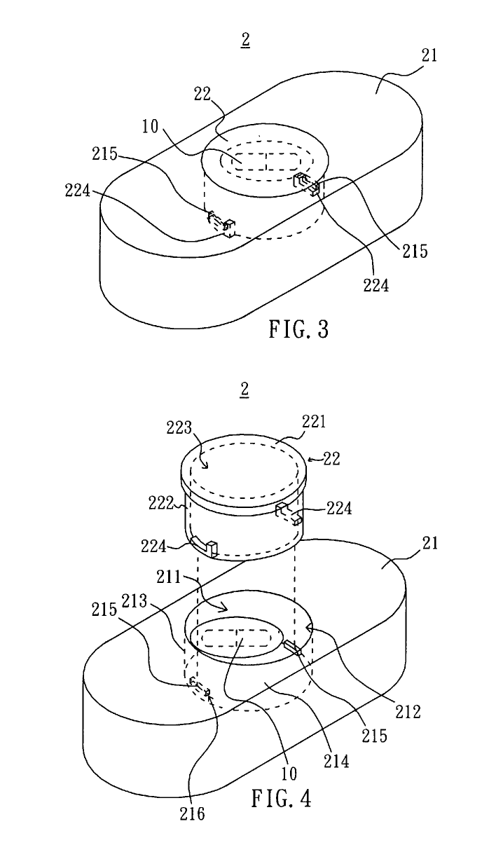

Referring to FIGS. 3 and 4, an edible medicine carrier 2 of a second preferred embodiment according to the present invention includes a main body 21 and a cover 22, where the main body 21 and the cover 22 are all made of an animal food material. An accepting space 211 is disposed inside the main body 21, and an opening 212 is disposed on the surface of the main body 21, where the opening 212 communicates with the accepting space 211. The main body 21 has a first wall 213 and a bottom face 214 both forming the accepting space 211. The first wall 213 has at least two projecting first engagement units 215. Where intervals 216 respectively between one end of the engagement unit 215 and the bottom face 214 and between another end thereof and the bottom face 214 are different. The cover 22 has a top face 221 corresponding to the opening 212 and a second wall 222 with a cross section smaller than the opening 212. The top face 221 and the second wall 222 surround a groove 223. The first wall 213 and the second wall 222 respectively are annular, and the second wall 222 has at least two second engagement units 224 corresponding to the first engagement units 215. The cover 22 can be coupled to the main body 21 fixedly and the top face 221 of the cover 22 is allowed to shield the opening 212 when the second wall 222 of the cover 22 is placed in the accepting space 211, one end of the second engagement unit 22 is aligned with the underside of the higher end of the first engagement unit 215, and the cover 22 is rotated to cause the second engagement unit 224 to be propped against the lower side of the first engagement unit 215 such that they are engaged with each other. The present embodiment can achieve the securing of the medicine 10 in the accepting space 211 of the main body 21 and the groove 223 of the cover 22.

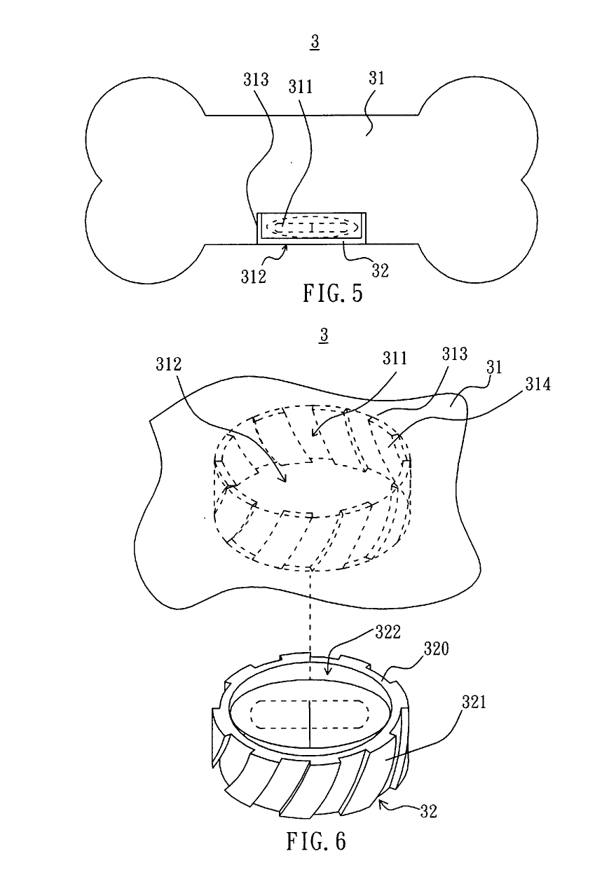

Referring to FIGS. 5 and 6, an edible medicine carrier 3 of a third preferred embodiment according to the present invention includes a main body 31 and a cover 32, where the main body 31 and the cover 32 are all made of an animal food material. An accepting space 311 is disposed inside the main body 31, and an opening 312 is disposed on the surface of the main body 31, where the opening 312 communicates with the accepting space 311. The main body 31 has a first wall 313 forming the accepting space 311. The cover 32 has a second wall 320 corresponding to the first wall 313. The first wall 313 and the second wall 320 respectively are annular, and respectively have a first engagement unit 314 and second engagement unit 321 corresponding to each other; the second wall 320 surrounds a groove 322. The first engagement unit 314 and second engagement unit 321 of the present embodiment respectively are two slanted convex-concave structures corresponding to each other. The cover 32 is allowed to couple fixedly to the main body 31 and shield the opening 312 when the two slanted convex-concave structures are aligned with each other and then the cover 32 is rotated to cause the two convex-concave structures to be engaged with each other. Whereby, the present embodiment can achieve the securing of the medicine 10 in the accepting space 311 of the main body 31 and the groove 322 of the cover 32.

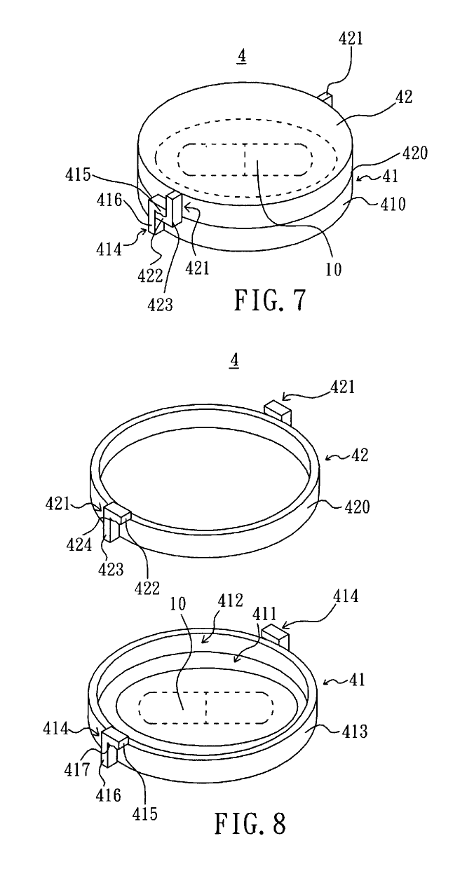

Referring to FIGS. 7, 8 and 9, an edible medicine carrier 4 of a fourth preferred embodiment according to the present invention includes a main body 41 and a cover 42, where the main body 41 and the cover 42 are all made of an animal food material. The main body 41 has an accepting space 411 and an opening 412, where the opening 412 communicates with the accepting space 411. The main body 41 has a first wall 413 forming the accepting space 411, and the cover 42 has a second wall 420. The first wall 413 and the second wall 420 respectively are annular. The first wall 413 and the second wall 420 respectively have a first engagement unit 414 and a second engagement unit 421 corresponding to each other; the first engagement unit 414 and the second engagement unit 421 are respectively projected from the first wall 413 and the second wall 420.

Referring to FIG. 8 again, the first engagement unit 414 of the present embodiment has a first engaging portion 415 and a first stopping portion 416, where the upper side of the first engaging portion 415 is higher than the upper side of the first wall 413, and the first engaging portion 415 is connected to the upper side of the first stopping portion 416. The second engagement unit 421 has a second engaging portion 422 and a second stopping portion 423, where the upper side of the second engaging portion 422 is higher than the upper side of the second wall 420, and the second engaging portion 422 is connected to the upper side of the second stopping portion 423. Furthermore, the first engaging portion 415 and the second engaging portion 422 respectively have a first tooth structure 417 and a second tooth structure 424 corresponding to each other, allowing the first engaging portion 415 and the second engaging portion 422 rather not to be separated from each other after being engaged with each other.

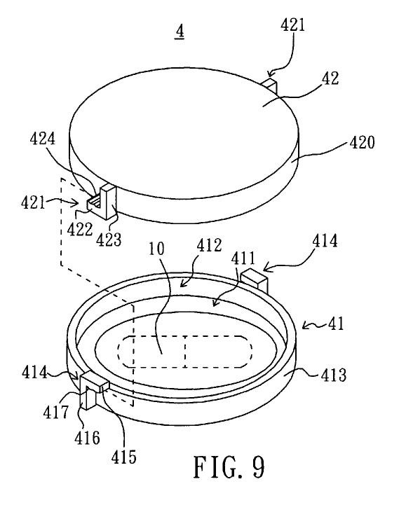

Referring to FIG. 9 again, the cover 42 can be coupled to the main body 41 fixedly and shield the opening 412 when the first engaging portion 415 and the second engaging portion 422 corresponding to each other are aligned with each other, the cover 42 is rotated to cause the first tooth structure 417 and the second tooth structure 424 to be propped against and buckled up with each other, and the first engaging portion 415 and the second engaging portion 422 are then respectively propped against the second stopping portion 423 and the first stopping portion 416 as FIG. 7 shows. The present invention can achieve the securing of the medicine 10 in the accepting space 411 of the main body 41. The main body 41 and the cover 42 of the present embodiment may also have the same shape and structure, thereby reducing facilities for manufacturing respectively the main body 41 and cover 42.

The edible medicine carrier of the present invention may be a cylinder, cube, ball, pyramid or irregular body such as bone. The edible medicine carrier of the present invention is formed by adding a material such as unformented or extremely less fermented grain powder, for example, flour, soybean powder or peanut powder with a little flavoring substance or spice and then molding and baking it.

The edible medicine carrier of the present invention may utilize general facilities for manufacturing animal food, reduce the cost with mass production. Feeding a pet medicine was inconvenient in the past such that pets has no opportunity to benefit from the biochemical technologies developed by the human beings, for example, vitamin, Viartril-s and etc. The present invention allows pets to benefit from the biochemical technologies, thereby enhancing pets' health.

The edible medicine carrier of the present invention allows medicine to be coupled to and secured in a soft, sticky edible material such as cheese or starch paste, and the soft, sticky edible material such cheese or starch paste to be dried and solidified under a condition of being stuck to an edible carrier. Medicine is rather not separated and scattered from the carrier even if the carrier is crumped by animals. The edible medicine carrier of the present invention has general shapes and odors of animal food such that it is convenient to be mixed together with the food to feed animals, ensuring that animals cannot differentiate between them and eat medicine effectively, thereby improving the deficits of the conventional edible medicine carrier substantially.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An edible carrier for animal medication, comprising:
a main body, having an accepting space for accepting an edible medicine and an opening, said opening communicating with said accepting space; said main body having a first wall forming said accepting space, said first wall having at least one first engagement unit; and
a cover, having a second wall, said second wall having at least one second engagement unit corresponding to said at least one first engagement unit;
wherein said main body and said cover respectively are made of an animal food material; said first wall and said second wall respectively are annular; said cover is coupled to said main body fixedly and shields said opening by engaging said engagement unit with said second engagement unit.

2. The edible carrier for animal medication according to claim 1, wherein said main body has a shape of said animal food.

3. The edible carrier for animal medication according to claim 1, wherein said first engagement unit and said second engagement unit respectively are internal threads and external threads corresponding to each other.

4. The edible carrier for animal medication according to claim 1, wherein said main body has a bottom face forming said accepting space; said first wall has at least two of said projecting first engagement units; an interval exits between said first engagement unit and said bottom face; said second wall has at least two of said second engagement units, thereby allowing said cover to be coupled to said main body fixedly when said second wall is placed into said accepting space, one end of said second engagement unit is aligned with a underside of said first engagement unit, and said cover is then rotated to cause said second engagement unit to be propped against a lower end of said first engagement unit and engaged therewith.

5. The edible carrier for animal medication according to claim 4, wherein different heights of intervals exist respectively between one end of said first engagement unit and said bottom face and between another end thereof and said bottom face.

6. The edible carrier for animal medication according to claim 5, wherein said cover has a top face corresponding to said opening; a cross section of said second wall is smaller than said opening; said top face and said second wall surround a groove.

7. The edible carrier for animal medication according to claim 1, wherein said first engagement unit and said second engaging unit respectively are two slanted convex-concave structures corresponding to each other.

8. The edible carrier for animal medication according to claim 1, wherein said first engagement unit has a first engaging portion and a first stopping portion; an upper side of said first engaging portion is higher than an upper side of said first wall; said first engaging portion is connected to an upper side of said first stopping portion, said second engagement portion has a second engaging portion and a second stopping portion; an upper side of said second engaging portion is higher than an upper side of said second wall; said second engaging portion is connected to an upper side of said second stopping portion, said first engaging portion is propped against and buckled up with said second engaging portion, and said first engaging portion and said second engaging portion are respectively propped against said second stopping portion and said first stopping portion when said first engagement unit is engaged with said second engagement unit.

9. The edible carrier for animal medication according to claim 8, wherein said first engaging portion and said second engaging portion respectively have a first tooth structure and a second tooth structure corresponding to each other.

10. The edible carrier for animal medication according to claim 9, wherein said main body and said cover has the same shape.

11. The edible carrier for animal medication according to claim 2, wherein said first engagement unit and said second engagement unit respectively are internal threads and external threads corresponding to each other.

12. The edible carrier for animal medication according to claim 2, wherein said main body has a bottom face forming said accepting space; said first wall has at least two of said projecting first engagement units; an interval exits between said first engagement unit and said bottom face; said second wall has at least two of said second engagement units, thereby allowing said cover to be coupled to said main body fixedly when said second wall is placed into said accepting space, one end of said second engagement unit is aligned with a underside of said first engagement unit, and said cover is then rotated to cause said second engagement unit to be propped against a lower end of said first engagement unit and engaged therewith.

13. The edible carrier for animal medication according to claim 12, wherein different heights of intervals exist respectively between one end of said first engagement unit and said bottom face and between another end thereof and said bottom face.

14. The edible carrier for animal medication according to claim 13, wherein said cover has a top face corresponding to said opening; a cross section of said second wall is smaller than said opening; said top face and said second wall surround a groove.

15. The edible carrier for animal medication according to claim 2, wherein said first engagement unit and said second engaging unit respectively are two slanted convex-concave structures corresponding to each other.
